(19) United States
(12) Patent Application Publication
(10) Pub. No.: US 2024/0026993 A1
(43) Pub. Date: Jan. 25, 2024

(54) PIPELINE JUNCTION COATING

(71) Applicant: TECHNIP N-POWER, Courbevoie (FR)

(72) Inventors: Corentin LAZARUS, Seattle, WA (US); Michael WHIGHAM, Aberdeen Aberdeenshire (GB)

(21) Appl. No.: 18/256,576

(22) PCT Filed: Dec. 9, 2021
(86) PCT No.: PCT/IB2021/000867

§ 371 Date: Jun. 8, 2023

(30) Foreign Application Priority Data
Dec. 11, 2020 (GB) 2019551.7

(51) Int. Cl. F16L 1/20; F16L 59/20; F16L 13/02; F16L 58/18; F16L 58/10

(52) U.S. Cl. CPC F16L 1/206; F16L 59/20; F16L 13/0272; F16L 58/181; F16L 13/02; F16L 58/1054

(57) ABSTRACT

The present invention relates to a pipeline junction coating between the joined ends of two coated metallic pipeline sections, the coating comprising an elongate body able to extend over the joined ends of the coated pipeline sections, and having a variable end profile at one or both ends. The pipeline junction coating is for coating field joints of coated rigid pipelines, as used in the subsea oil and gas industry.

The present invention relates to a pipeline junction coating for use with coated pipelines, and in particular to coating field joints of coated rigid pipelines, as used in the subsea oil and gas industry.

The fluid may be water, oil and/or gas, and possibly solid particles such as sand. A rigid pipeline can be laid in a lake, a sea or an ocean, of a water depth comprised between 50 m and 4000 m. A rigid pipeline can be used to transport a fluid from a subsea structure to a surface installation. The subsea structure is for example a manifold, a wellhead, a Xmas Tree and the surface installation is for example a vessel such as a FPSO (Floating Production Storage and Offloading) or a platform such as a TLP (Tension Leg Platform).

Rigid subsea pipelines are commonly formed of lengths of steel pipe—‘pipe joints’—that are welded together end-to-end. Pipe joints are typically about 12 m in length but may be manufactured in multiples of that length. Such pipe joints are aligned and girth welded together on a production line to form pipe stalks, which are typically about 1 km in length.

The fluid transported by the pipeline may comprise small particles of gases such as CO2 or H2S that may damage the steel pipe by corrosion. To limit corrosion, the internal surface of the pipe is generally lined with a metallic clad or a plastic pipe. In a variant, the steel pipe is made of a carbon steel with sour service performances, like Corrosion Resistant Alloys (CRAs) stainless steel, for example super martensitic stainless steel or duplex stainless steel.

Meanwhile, sea water can reach very low temperature, and thus the temperature inside the pipeline can also decrease. Combined with the high internal fluid pressures involved, hydrates, wax and ice plugs may be formed in the bore of the pipeline. Such plugs can decrease the production rate and also damage the pipe.

To alleviate the decrease of temperature inside the pipeline, and to help prevent the formation of plugs in the pipe bore, an outer thermal insulation coating is generally located around the outside of each section or joint of pipes. The outer coating is generally composed of an initial anti-corrosion coating layer, such as a Fusion Bonded Epoxy (FBE) base layer, onto which is applied a 3-layer polyolefin coating, such as a three-layer polyethylene (3LPE) or a three-layer polyolefin (3LPP), depending on the pipeline production temperature.

Typically, a polymer with a low thermal conductivity such as polypropylene is preferred. Polypropylene (PP) is commonly used as the pipeline coating material for pipe joints from which pipelines are fabricated. For example, a three-layer PP coating comprises a first layer of epoxy primer, a second thin layer of PP bonded with the primer, and a third, thicker layer of extruded PP applied over the second layer. A five-layer PP coating adds two further layers, namely a fourth layer of PP modified for thermal insulation, such as glass syntactic PP (GSPP) or a foam, surrounded by a fifth layer of extruded PP for mechanical protection of the insulating fourth layer.

For joining the pipe joints, a length of pipe is typically left uncoated at each end of a pipe joint to facilitate welding between abutting pipe joints, and to form what is termed in the art a field joint. After welding, the resulting field joint comprises two bare steel pipe ends of the abutting pipe joints, and the butt weld that joins those pipe joints together. Consequently, the field joint defines a gap in the pipeline coating.

Once the weld between abutting pipe joints passes testing, the field joint must be coated with a field joint coating to mitigate corrosion and to maintain the necessary degree of insulation. A ‘field joint coating’ (commonly simply termed a ‘FJC’) fills the gap in the pipeline coating so that the joined pipeline is then covered by a continuous thermal insulation extending across the field joints between the successive pipe joints. Otherwise, cold spots may arise that could promote clogging of the pipeline by solid condensates. A design constraint particularly of reel-lay pipelines is that the outer diameter of the field joint coating cannot be significantly different to the outer diameter of the pipeline coatings on the adjacent pipe joints.

Several methods exist for forming a FJC. It is for example formed by the Injection Moulded Polyurethane (IMPU) method. The polyurethane is cured in a mould placed around the field joint to be coated.

In an IMPU process, the exposed pipe surface at the abutting welded ends of the pipe joints is cleaned and a primer is applied to promote adhesion. A mould is then positioned to enclose the field joint and a two-component urethane material is cast into the annular cavity defined within the mould around the field joint. The urethane then cures, cross-linking and solidifying to form polyurethane (PU) in an irreversible chemical reaction. When the PU has cured sufficiently, the mould is removed to leave the field joint coating in place around the field joint.

Another approach is to use polypropylene (PP) as the field joint coating in an injection moulded polypropylene (IMPP) process. An example of an IMPP process is disclosed in WO 2012/004665. In an IMPP process, the exposed pipe surface at the abutting welded ends of the pipe joints is cleaned, primed and heated, for example using induction heating or gas flames. Exposed chamfers at the adjacent ends of the pipeline coatings are also heated. The field joint is then enclosed by a mould that defines an annular cavity around the field joint. Molten PP is injected into the cavity under high pressure. Once the PP has cooled sufficiently, the mould is removed, leaving a tube of PP around the field joint as the field joint coating. This tube is continuous with the tubular pipeline coating surrounding the pipe joints, such that the same or compatible coating materials extend all along the length of the pipe string.

The existing pipe coating is pre-heated before injection moulding, and the molten field joint coating fuses with the heated pipe coating surface upon contact. Typically, many pipe joints are welded together offshore aboard an installation vessel as the pipeline is laid, typically by S-lay or J-lay methods. It is also common to fabricate pipe stalks from pipe joints onshore at a spoolbase or yard and then to weld together the pipe stalks end-to-end to spool the prefabricated pipeline onto a reel. The spooled pipeline is then transported offshore for laying in a reel-lay operation.

However, generally, the material of the outer coating and the field joint coating are not the same, and thus the bond strength between the outer coating and the field joint may not be satisfactory. The lack of bonding at the interface between the outer coating and the field joint, in particular during spooling, laying, or in service of the pipeline, could therefore introduce a risk of water ingress and corrosion of the pipe. In addition, the lack of bonding reduces the thermal insulation performance of the rigid pipe.

In general, the use of a polypropylene based material for the FJC may be preferred as the strength of bonding between two materials of the same nature is generally higher than the bonding between two dissimilar materials such as a PU and a PP. However, there can still be issues if the PP used for FJC and the PP of the outer coating are slightly different, in particular in terms of rigidity due to different extrusion parameters and different grades of material used.

Where a difference in rigidity occurs, the interface between the two PP materials when bent together causes large stress concentrations to occur in the less resistive material, resulting in either disbondment and/or cracking at the interface. Disbondment and/or cracking leads also to water ingress, that then results in corrosion of the outer surface of the pipe. Cracks also reduce thermal insulation performance of the pipe.

Stresses and strains are particularly experienced during and after a pipeline is laid, especially during laying as the pipeline is deflected during spooling and laying onto a reel, and over an overbend or through a sag bend as the case may be. The stresses and strains are typically most severe when spooling a coated pipeline onto a reel, which, as mentioned above, involves plastic deformation of the steel of the rigid pipe. The reel, acting as a bending mandrel, also imparts concentrated deformation forces directly to the coating that act through the coating on the underlying steel pipe.

When a pipeline undergoes substantial bending, cracks will tend to appear and de-bonding will tend to occur at the interfaces between field joint coatings and pipeline coatings. When applying field joint coatings to a reeled pipeline, the approach taken in the prior art to solve the problem of cracking has been to stiffen the field joint coating system. For example in WO 2012/072894, an external stiffener sleeve is used to form a sandwich field joint coating. In WO 2010/049667, a stiffer reinforced part of the field joint coating is moulded as a preliminarily step. Disadvantageously, both of those solutions increase the time required to produce the field joint coating.

WO 2016/102953 also discloses using an insulating insert in a FJC based on a series of linked flexible inserts to facilitate bending of the insert along its length, but this still requires having a supply of such inserts available, and delicately locating the insert into the FJC during its forming.

Indeed, the presence of an insert adds further interfaces and gives rise to additional stress and strain concentrations within the field joint coating, which increases the risk of cracks appearing. Any such cracks may allow water to reach the outer surface of the steel pipe, thus corroding the pipe. Water ingress may also reduce the adhesion of the coatings to the pipe and may additionally degrade the coatings themselves. An example of such degradation is hydrolysis of a PU field joint coating under heat emanating from within the pipeline in use, which is particularly significant under the high-pressure conditions of deep water. Degradation or loss of adhesion of the coatings will tend to permit further corrosion of the pipe and to lead to a failure of thermal insulation.

It is an object of the present invention to provide an improved FJC and formed pipeline.

### SUMMARY

In one aspect of the present invention, there is provided a pipeline junction coating between the joined ends of two coated metallic pipeline sections, the coating comprising an elongate body able to extend over the joined ends of the coated pipeline sections, and having a variable end profile at one or both ends.

According to another aspect of the present invention, there is provided a pipeline assembly comprising two metallic coated pipe sections joined at a pipe junction, each pipe section pre-coated up to the pipe junction with a first outer polymeric thermal insulating coating, and a pipeline junction coating as defined herein applied between the ends of the two metallic pipeline sections.

According to another embodiment of the present invention, there is provided a method of coating a pipeline junction between two coated metallic pipeline sections comprising at least the steps of:
(a) positioning a mould tool around a field joint to define a mould cavity, the mould tool having one or more shaping tools with a variable profile at one or both ends of the mould tool; and
(b) injecting a polymer material into the mould cavity to form a pipeline junction coating having a variable end profile at one or both ends.

According to another aspect of the present invention, there is provided a mould tool having one or more shaping tools with a variable profile at one or both ends of the mould tool. The mould tool is suitable for positioning around a pipeline junction to define a mould cavity, allowing injection of thermoplastics material into the mould to fill the mould cavity to form a field joint coating; and able to form a pipeline junction coating having a variable end profile at one or both ends.

### DESCRIPTION OF THE DRAWINGS

Embodiments of the present invention will now be described by way of example only, and with reference to the accompanying drawings in which:

FIG. 1 is a schematic sectional side view of a coated field joint of a pipeline as known in the prior art;

FIG. 2 is a perspective view of a pipeline field joint fitted with an coating according to one embodiment of the present invention;

FIG. 3 is a side cross-sectional view of FIG. 2;

FIG. 4 is a side part-cross-sectional view of a moulding tool and a method of forming a field joint coating according to further embodiments of the present invention;

FIG. 4a is a section view along line AA of FIGS. 4; and

FIG. 5 is a perspective view of a shaping tool of FIG. 4.

### DETAILED DESCRIPTION OF THE DRAWINGS

The present invention provides a pipeline junction coating between the joined ends of two coated metallic pipeline sections, the coating comprising an elongate body able to extend over the joined ends of the coated pipeline sections, and having a variable end profile at one or both ends.

The pipeline junction coating may be formed of a mouldable material. The mouldable material may be formed from one or more substances, compounds or components. Optionally, the pipeline junction coating is formed of a material adapted to work with the moulding process to be used.

Optionally, the pipeline junction coating is formed from a polymer material, which includes but is not limited to one or more of polypropylene and polyurethane. Typically, polyurethane provides thermoset materials, which are more suitable for casting or injection-moulding techniques, and which cure and harden by cross-linking, whilst polypropylene typically provides thermoplastic materials, which cure and harden by cooling, and which are more typically used for injection moulding, for example by placing polypropylene pellets in a mould placed over the area to be coated, and heating the mould in order to melt the pellets and form the coating.

Where the outer coating of the two coated metallic pipeline sections being joined and coated by the pipeline junction coating of the present invention are formed of a polypropylene material, the use of a polypropylene based material for the pipeline junction coating is preferred to assist the bonding parameters or conditions, such as the strength of bonding, between the two coating materials.

The pipeline junction coating has a variable end profile at one or both ends, optionally both ends of the elongate body. The variable end profile comprises partly, substantially or fully the circumferential end of the pipeline junction coating.

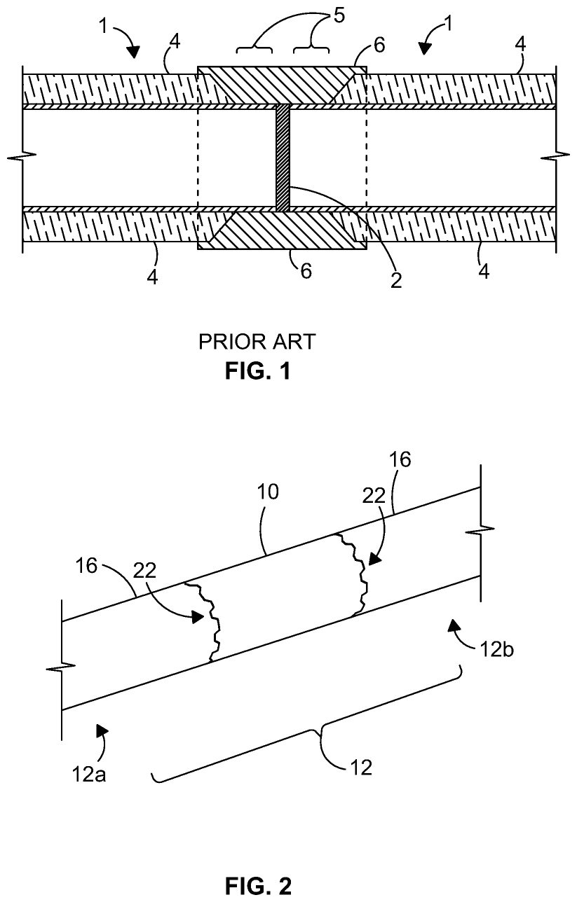

The variable end profile may be any suitable profile able to disrupt the stress concentration that is created in a straight circumferential ends of conventional and known field joint coatings, such as that described hereinafter in relation to FIG. 1.

The variable end profile of the pipeline junction coating of the present invention may comprise a regular variation in geometry relative to the adjacent circumference of the pipeline, or an irregular variation in geometry, or a combination of same, at different portions of one or both circumferential ends of the pipeline junction coating.

One example of a regular variation in geometry is a castellation profile, generally formed by alternating regular protrusions and recesses.

Another example of a variable end profile is a sinusoidal form.

To describe an example of an irregular variation in geometry may be for a castellation profile or sinusoidal profile, generally formed respectively by alternating protrusions and recesses, wherein the protrusions are of different length and/or width and the sinusoidal form is of different period and/or amplitude.

The variable end profile of one or both ends of the pipeline junction coating of the present invention is not limited to the nature of the profile and its regularity. The variable end profile of one or both ends of the pipeline junction coating can be based on having a ‘smooth’ profile having no significant or sharp angles, or based on having a more angular profile. The variable end profile of one or both ends of the pipeline junction coating can comprise variation in the end profile at one or more portions of the end, including the length or depth of any protrusion or recess in relation to other protrusions or recesses.

In one embodiment of the present invention, the pipeline junction coating has a variable end profile at both ends of the coating, which profile comprises regular castellation.

In another embodiment of the present invention, the pipeline junction coating comprises a variable end profile which is sinusoidal.

In another embodiment of the present invention, the pipeline junction coating comprises variable end profiles at both ends formed of alternating protrusions and recesses.

Optionally, the pipeline junction coating comprises a field joint coating for use at a field joint between two conjoined metallic coated pipe sections.

Optionally, the pipeline junction coating is a field joint coating, i.e. a coating able to be applied over a weld made between the ends of two coated pipe sections, which ends are deliberately free from outer coating to allow them to be welded at a pipe junction without damaging the outer coating, and which coating is intended to protect the pipe from corrosion and to ensure a continuous thermal insulation of the pipe.

As such, the present invention extends to a pipeline assembly comprising two metallic coated pipe sections joined at a pipe junction, each pipe section pre-coated up to near the pipe junction with a first outer polymeric thermal insulating coating, and a pipeline junction coating as defined herein applied between the ends of the two metallic pipeline sections.

Optionally, the pipeline assembly of the present invention is an assembly as part of or within a longer rigid pipeline. Rigid subsea pipelines encompass a large family of pipelines, for example:
Single pipelines
Plastic lined pipelines (PLP)
Mechanically lined pipes (MLP)
Corrosion resistant alloy pipelines (CRA pipes)
Direct electrically heated pipelines (DEH Pipes)
Pipe-in-Pipe (PiP)
Electrically trace heated pipe-in-pipe (ETH-PiP)

Rigid subsea pipelines are commonly formed of lengths of steel pipe that are welded together end to end. Rigid pipes are still intended to have some flexibility to allow some degree of bending if a minimum bend radius is observed. The construction and manufacture of rigid pipes are specified in API 5 L ‘Specification for Line Pipe’ published by the American Petroleum Institute, Edition March 2004 or/and in ISO 3183:2012 published by the International Organization for Standardization in November 2012 and are exemplified by WO 2014/080281, typically comprising at least one pipe of solid steel or steel alloy, optionally with an internal metal cladding or plastic liner layer and/or an outer coating layer, and for laying at a water depth which can extend down to 4000 m.

Optionally, the present invention extends to a pipeline assembly as defined above wherein the pipe junction of the present invention is a field junction.

Optionally, the pipeline assembly of the present invention comprises a pipeline junction coating which is chemically bonded to an outer polymeric thermal insulation coating on each of the metallic pipeline sections at a bonding interface.

Optionally, the bonding interface comprises a variable profile, in particular a variable profile being the same as the variable end profile as defined herein.

Optionally, the pipeline junction coating has or forms a bonding interface with the coated metallic pipeline sections on either side of the field joint.

The pipeline junction coating extends to overlap with or to otherwise cover the ends of the coated metallic pipeline sections, to thereby provide a continuous coating along the joined pipeline. The variable end profile at one or both ends of the pipeline junction coating preferably fully overlaps with the end or ends of the coated metallic pipeline sections.

The pipeline junction coating may be applied using any of the methods as discussed herein, including but not limited to the injection moulded polyurethane method and the injection moulded polypropylene method. Such methods can use a pipeline junction coating mouldable material, in particular a polymer material such as polypropylene or polyurethane as discussed herein, which material is able to be formed into the pipeline junction coating by a moulding process.

The nature and form of the pipeline junction coating formed by the method may be as described herein, in particular forming a variable end profile as described herein, including but not limited to castellation, such as regular castellation, based on a circumferential edge of the pipeline junction coating having alternating protrusions and recesses.

The method of the present invention involves shaping one or both ends of the elongate body of the pipeline junction coating to form the variable end profile. The shaping of one or both ends of the elongate body of the pipeline junction coating may be carried out by any known shaping process. Typically, the shaping is carried out during forming of the pipeline junction, for example by a mould tool or mould tools having ends with a complementary profile to the desired variable end profile of the pipeline junction coating, or the shaping is otherwise workable to provide such variable end profile during the coating.

In one embodiment of the present invention, the method comprises coating a pipeline junction between two coated metallic pipeline sections comprising at least the steps of:
(a) positioning a mould tool around a field joint to define a mould cavity, the mould tool having one or more shaping tools with a variable profile at one or both ends of the mould tool; and
(b) injecting a moulding material into the mould cavity to form a pipeline junction coating having a variable end profile at one or both ends.

In one embodiment, a pipeline junction coating moulding material is a thermoplastics material, that can enter a suitable mould seal or mould tool or mould tools, to fill the mould cavity created by the mould tool, and then form the final field joint coating by curing and hardening by cooling.

Optionally, the thermoplastic material is polypropylene (PP). A thermoplastic material is typically provided as a solid or higher viscosity material, which is heated, melted, and then injected, typically at a high pressure such as 150 bar, into the mould tool. The liquid material is designed to ‘pack into’ all the cavities of a mould tool before setting, typically followed by being quenched.

One suitable injection process is the IMPP process discussed above.

Where the pipeline coatings are formed from a polypropylene material, it may be preferred that the pipeline junction coating moulding material is substantially or wholly formed from a polypropylene material, so as to increase the similarity of these materials to assist bonding thereinbetween.

In another embodiment, the pipeline junction coating moulding material is a thermoset material, typically having two components that cure upon contact and mixing. One example of a thermoset material is polyurethane (PU). One component may be a resin such as a polyol resin, and another component may be a cross-linker such as an isocyanate. Optionally, a catalyst is also included. The components are typically stored separately, and then mixed immediately prior to injection into the mould to react and cure to form a pipeline junction coating. A thermoset material typically requires no heat, or high heat, and no pressure, or high pressure for injection and setting. One suitable injection process is the IMPU process discussed above.

The method includes using a suitable shaping tool or shaping tools or mould sealing end or mould sealing ends, to one or both the ends of a mould tool or to each mould tool to provide a complementary variable end profile thereto.

Mould tools are generally known in the art, and comprise one or more elongate parts positionable around a pipeline to define a mould cavity. A typical mould tool is a half-shell, such that two half shells are formable around a pipeline, in particular a pipeline formed from sections and joined together with a field joint. Typically, one or more of the mould tools have one or more ports through which a moulding material may be injected into the mould cavity to form a field joint coating that sets in the mould cavity.

The or each shaping tool may be fixed to a mould tool by welding, bolting or other fixation means and devices. Preferably, the or each shaping tool is an integral part of the mould tool.

Optionally, a shaping tool is a separable part of a mould tool, such that a mould tool can use one or more different shaping tools, or indeed no shaping tool if not required.

The shaping tool may be in the form of a collar or part collar, such as a half collar able to be located around a metallic pipeline section, and either fully or partly enclosable within the or a mould tool, such that the pipeline junction coating moulding material is shaped following its abutment against the shaping tool and the mould tool. Such collars or collar portions could be fixed by welding or bolts to the end or ends of a mould tool. Alternatively, such collars or collar portions are additional to the mould tool, and they can then be removed when the mould tool is removed following the forming, typically after the curing and hardening of the pipeline junction coating.

Thus, the method can further comprise the step of fixing one or more shaping tools with a variable profile to one or both ends of the mould tool prior to step (a).

Optionally, the mould tool comprises two half shells, and each half shell comprises a half-shell shaping tool at each end.

The method of the present invention can provide a pipeline junction coating as defined herein. Optionally, the method of the present invention can provide a profile of both ends of a pipeline junction coating comprises regular castellation.

Optionally, the method of the present invention is for forming a field joint coating between two coated metallic pipeline sections. The two coated metallic pipeline sections can be rigid pipeline sections as defined herein.

Embodiments of the present invention will now be described by way of example only and reference to the following drawings.

Referring to the drawings, FIG. 1 shows a prior art arrangement for a field joint created between two abutting pipe joints 1 of a pipeline, where a circumferential butt weld 2 attaches the pipe joints 1 to each other end-to-end. Each pipe joint 1 is coated with an insulating pipeline coating 4 which terminates before the end of each pipe joint 1, with a typically chamfered end shape.

An annular gap 5 lies between the opposed ends of the pipeline coatings 4 around the weld 2, where the exposed external surfaces of the pipe joints 1 are coated with an insulating field joint coating 6 that substantially matches the radial thickness of the pipeline coatings 4. The field joint coating 6 may be made using a mould tool (not shown) fixed around the field joint. The mould tool extends from one pipeline coating 4 to the other and overlaps those coatings 4 to define a mould cavity that includes the annular gap 5 between the coatings 4 and that surrounds the field joint. A liquid polymer such as PU or PP is injected or otherwise introduced into the mould cavity to harden in the mould cavity before the mould tool is removed to coat another field joint of the pipeline.

However, it can be seen from FIG. 1 that the circumferential edge of each end of the field joint coating 6 is constant or ‘straight’. Where the material of the field joint coating 6 is different to the material of the parent coatings 4, there is potentially some difference in terms of rigidity due to the different extrusions parameters used, and the different grades of materials used.

Where a difference in rigidity also occurs, the interface between the two materials when bent together causes large stress concentrations to occur in the less resistive material, resulting in either disbondment or cracking. Any stress concentration has no method of translating stress elsewhere, leading to the possibility of cracks being observed in the pipeline coating 4, or in the junction between the pipeline coating 4 and the field joint coating 6. Cracks lead to water ingress that results in corrosion at the outer surface of the pipe 1, as well as reducing thermal insulation performance of the pipeline. Any subsea pipeline crack or corrosion is typically not observable, but can lead to catastrophic failure of the pipeline.

FIG. 2 shows a pipeline junction coating 10 according to one embodiment of the present invention, as well as a pipeline assembly 12 according to another embodiment of the present invention.

The pipeline junction coating 10 has variable end profiles 22 discussed further below.

The pipeline assembly 12 comprises two metallic coated pipe sections 12a, 12b joined at a pipe junction 14, with each pipe section 12a, 12b pre-coated close to the pipe junction 14 with a first outer polymeric thermal insulating coating 16.

The pipe sections 12a, 12b may be for example pipe joints, forming part of a pipeline 12 which may be a rigid subsea pipeline as described herein, for laying subsea at a water depth between 50 m and 4000 m, and designed to transport a fluid, for example hydrocarbons, water or gas, from a subsea structure to a surface installation or the other way round. To limit the corrosion possible from some fluids, the internal surfaces of the pipe sections 12a, 12b are lined with a metallic cladding or plastic liner pipe 18 in a manner known in the art.

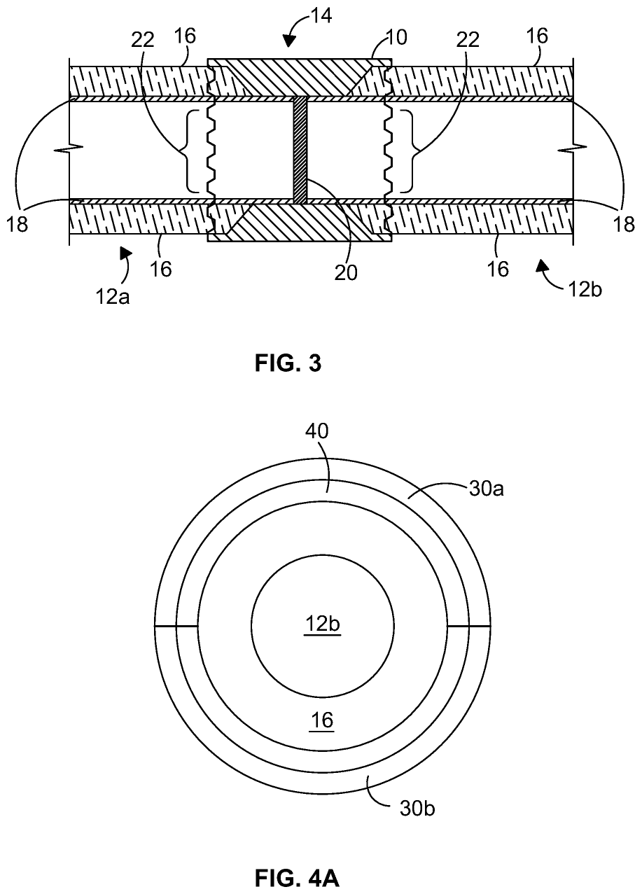

The pipeline sections 12a, 12b are conjoined to form a longer pipeline, typically by a butt weld 20 as shown in FIG. 3, access to which is possible because the pipeline coatings 16 have been not formed up to, or have been cut back from, the ends of the pipeline sections 12a, 12b, typically in a chamfered or bevelled shape as shown in FIG. 3.

As described herein, it is now desired to coat the butt weld 20 between the pipeline coating 16, to mitigate pipeline corrosion, and to maintain the necessary degree of insulation along the length of the pipeline assembly 12. A field joint coating fills the gap in between the pipeline coating 16, and the general method of coating the pipeline junction between the two coated metallic pipeline sections 12a, 12b, can be based on methods known in the art, such as the Injection Moulded Polyurethane (IMPU)) method or the injection moulded polypropylene (IMPP) method.

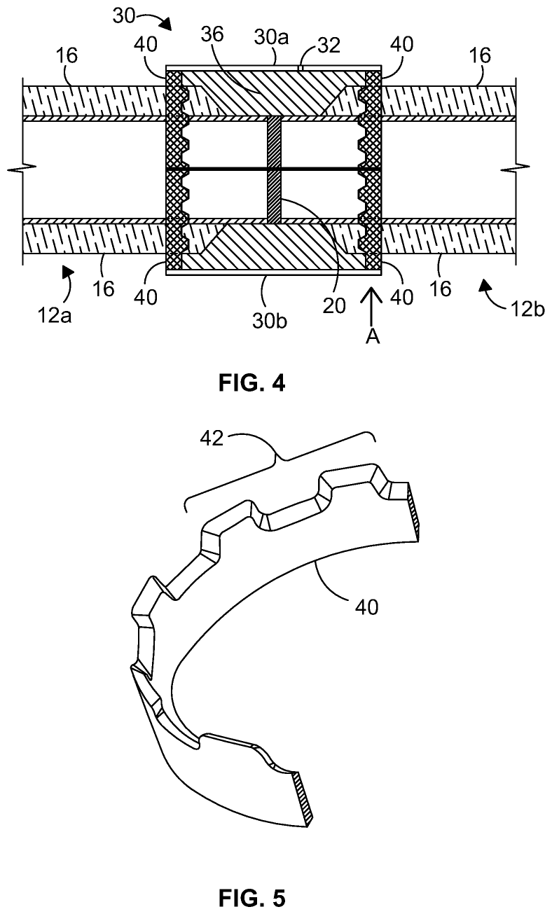

FIG. 4 shows a mould tool 30 useable as part of the present invention, encircling a field joint or butt joint 20 formed between the pipeline sections 12a, 12b, optionally at a suitable coating stage, coating station, or other part of the junction-forming process (not shown).

Typically, the mould tool 30 comprises an elongate tube of generally circular inner cross section, divided longitudinally into two half shells 30a, 30b. The two semi-circular half shells 30a, 30b are each locatable around the ends of the pipeline sections 12a, 12b to form a complete outer shell or casing, so as to fully surround and cover a proportion of the pipeline coating 16 of each of the pipeline sections 12a, 12b, as well as covering the field joint 20 thereinbetween. The two semi-circular half shells 30a, 30b may be as known and used in the art.

FIG. 4a is section through the embodiment of FIG. 4 along lines AA. FIGS. 4 and 4a show the positioning of two semi-circular collars or shaping tools 40 at each end of the two semi-circular half shells 30a, 30b, to form a complete and tight ‘ring’ around the pipeline coating 16 of each pipeline section 12a, 12b. A pipeline section 12a, 12b and its coating 16 has a typical outer circumference either known in the art or measureable, and suitable shaping tools 40 can easily be formed to match the required pipeline and coating circumference.

FIG. 5 is a perspective view of the shaping tool 40, wherein one longitudinal side of the shaping tool 40 is formed in a regular castellation profile, i.e. of alternating protrusions and recesses, generally having smoothed edging or edges. The shape of the shaping tool 40 is complementary to the profile of the variable end profiles 22 to be formed with the pipeline junction coating 10 as shown in FIG. 2.

The embodiment of FIG. 4 uses four shaping tools 40, all of the same shape. However, the skilled reader can see that shaping tools having a different profile can just as easily be used with the mould tool 30 to form a pipeline junction coating between joined ends of two coated metallic pipeline sections having different variable end profiles, and/or different end profiles at one or both ends of the coating.

FIGS. 4 and 4a show the shaping tools 40 located at the ends of each of the half shells 30a, 30b, and located tightly between the half shells 30a, 30b and the pipeline sections 12a, 12b. The shaping tools 40 may be welded to the inner surfaces of the half shells 30a, 30b, so as to be positionable around the pipeline sections 12a, 12b as the half shells 30a, 30b are being positioned around the pipeline sections 12a, 12b.

Alternatively the shaping tools 40 may be initially positioned on the pipeline sections 12a, 12b, followed by positioning of the half shells 30a, 30b, followed by fixing the shaping tools 40 and the half shells 30a, 30b together.

The shaping tools 40 form the ends of a cavity 36 provided by the mould tool 30.

A suitable port 32 is (or multiple ports are) part of the mould tool 30 for the entry passage of a suitable material, in particular a pipeline junction coating moulding material, into the mould tool 30 once assembled together to encircle the field joint 20, such that the material fills the cavity 36 within the mould tool 30. Typically, the mould tool 30 includes one or more vents (not shown) to allow air to escape from the cavity 36 following the injection of the pipeline junction coating material thereinto.

Optionally, the mould tool 30 includes a temperature control means (such as heating/cooling means, generally being one or more wires or pipes or temperature transfer means), able to affect the temperature of the moulding material to allow its curing and hardening, typically by cooling.

In use, after forming the butt weld 20, the moulding tool 30 is located around each of the pipeline coatings 16 of the metallic pipe sections 12a, 12b so that the two shaping tools 40 at each end of each half shell 30a, 30b form a complete circumferential ring around each of the pipeline coating 16.

Once the mould tool 30 is located and secured in place, the cavity 36 within the mould tool 30 can be filled by injection of the pipeline junction coating moulding material through the port 32. Optionally, the moulding material is added or injected into the cavity 36 under pressure, so as to ensure complete filling of the cavity 36, following the venting of air therefrom (not shown).

In one embodiment, the pipeline junction coating moulding material is a thermoplastic material such as polypropylene (PP). A thermoplastic material is typically provide as a solid or higher viscosity material, which is heated to e.g. around 175° C., melted and then injected, typically at a high pressure such as 150 bar, into the mould 30. The liquid material is designed to ‘pack into’ the mould 30 before setting, followed by being quenched.

One suitable process is the IMPP process discussed above. Where the pipeline coatings 16 are formed from a polypropylene material, it may be preferred that the pipeline junction coating moulding material is substantially or wholly formed from a polypropylene material, so as to increase the similarity of these materials to assist bonding thereinbetween.

In another embodiment, the pipeline junction coating moulding material is a thermoset material, typically having two components that cure upon contact and mixing. One example is polyurethane (PU). One component may be a resin such as a polyol resin, and another component may be a cross-linker such as an isocyanate. Optionally, a catalyst is also included. The components are typically stored separately, and then mixed immediately prior to injection into the mould to react and cure to form a pipeline junction coating between the joined ends of two coated metallic pipeline sections having a variable end profile at one or both ends. The thermoset components can be pumped from storage tanks at the correct ratio into a dispensing head (not shown in FIG. 4) connected to the mould tool 30, which includes a static mixer (not shown) with one outlet of the mixed liquid for the port 32.

A thermoset material typically requires no heat, or high heat, and no pressure, or high pressure for injection and setting. One suitable process is the IMPU process discussed above.

As the moulding material sets, typically either cures and hardens (PU) or melts and solidified (PP), to form the pipeline junction coating 10, the ends of the pipeline junction coating 10 are formed to have a variable end profile being complementary to the profile of the shaping tools 40, so as to provide the variable end profiles shown in FIGS. 2 and 3. Once the pipeline junction coating 10 has been formed, the mould tool 30 can be removed so as to leave the final pipeline junction coating 10 coating the field joint 20, and coating the ends of the pipeline coating 16 of each of the two coated metallic pipeline sections 12a, 12b, to form a pipeline assembly as per the present invention.

Alternatively, further operations can be carried out following the forming/shaping of the pipeline junction coating. For example, the pipeline junction coating is cooled or quenched within a cooling/quenching station and the residual burr resulting from the shaping operation is deburred to obtain a clean and smooth pipeline junction coating outer surface.

The variable end profiles 22 of the pipeline junction coating 10 allow for the transfer or dissipation of stress between the pipeline junction coating 10 and the pipeline coating 16 following any bending of the pipeline 12, by disrupting the stress concentration caused by the bending, and so avoiding the stress concentration that otherwise occurs at the location of maximum stress between the pipeline junction coating and the pipeline coatings that would otherwise occur. This provides more assurity to the manufacturer of the integrity of the bonding or seal between the pipeline junction coating and the pipeline coatings during any bending of the pipeline, in particular during any spooling, unspooling, straightening or laying of the pipeline from a vessel to an undersea environment.

1. A pipeline junction coating between the joined ends of two coated metallic pipeline sections, the coating comprising an elongate body able to extend over the joined ends of the coated pipeline sections, and having a variable end profile at one or both ends.

2. A pipeline junction coating as claimed in claim 1 comprising a mouldable material.

3. A pipeline junction coating as claimed in claim 2 wholly or substantially formed from a polymer material.

4. A pipeline junction coating as claimed in claim 3 wherein the polymer material is polypropylene or polyurethane.

5. A pipeline junction coating as claimed in claim 1 having a variable end profile at one or both ends comprising a regular variation in geometry.

6. A pipeline junction coating as claimed in claim 1 wherein a variable end profile comprises a castellation profile.

7. A pipeline junction coating as claimed in claim 1 wherein both ends of the coating comprise regular castellation.

8. A pipeline junction coating as claimed in claim 1 wherein a variable end profile is sinusoidal.

9. A pipeline junction coating as claimed in claim 1 having a variable end profile at one or both ends comprising an irregular variation in geometry.

10. A pipeline junction coating as claimed in claim 1 being a field joint coating.

11. A pipeline junction coating as claimed in claim 10 comprising a field joint coating for use at a field joint between two conjoined metallic coated pipe sections.

12. A pipeline assembly comprising two metallic coated pipe sections joined at a pipe junction, each pipe section pre-coated up to the pipe junction with a first outer polymeric thermal insulating coating, and a pipeline junction coating as defined in claim 1 applied between the ends of the two metallic pipeline sections.

13. A pipeline assembly as claimed in claim 12 being a rigid pipeline.

14. A pipeline assembly as claimed in claim 12 wherein the pipe junction is a field junction.

15. A pipeline assembly as claimed in claim 12 wherein the pipeline junction coating is chemically bonded to the first outer polymeric thermal insulation coating on each of the metallic pipeline sections at a bonding interface.

16. A pipeline assembly as claimed in claim 15 wherein the bonding interface comprises a variable profile.

17. A method of coating a pipeline junction between two coated metallic pipeline sections comprising at least the steps of:
(a) positioning a mould tool around a field joint to define a mould cavity, the mould tool having one or more shaping tools with a variable profile at one or both ends of the mould tool; and
(b) injecting a moulding material into the mould cavity to form a pipeline junction coating having a variable end profile at one or both ends.

18. A method as claimed in claim 17 further comprising the step of fixing one or more shaping tools with a variable profile to one or both ends of the mould tool prior to step (a).

19. A method as claimed in claim 17 wherein the mould tool comprises two half shells, and each half shell comprises a half-shell shaping tool at each end.

20. A method as claimed in claim 17 wherein the moulding material is polypropylene or polyurethane.

21-23. (canceled)
